(19) United States
(12) Patent Application Publication
(10) Pub. No.: US 2009/0094158 A1
(43) Pub. Date: Apr. 9, 2009

(54) Method and Apparatus for Processing and Transmitting Demographic Data Based on Secondary Marketing Identifier in a Multi-Computer Environment

(76) Inventors: Gene S. Fein, Lenox, MA (US); Edward Merritt, Lenox, MA (US)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 11/869,460

(22) Filed: Oct. 9, 2007

(51) Int. Cl. G06Q 30/00; G06Q 10/00; H04L 9/32

(52) U.S. Cl. 705/50; 705/14; 705/10

(57) ABSTRACT

A method and system for transmitting targeted marketing opportunities to a user includes providing a primary identifier associated with a transaction account, and a secondary identifier associated with a marketing account. Received transaction information related to the transaction account is associated with the secondary identifier and stored. A user is associated with the secondary identifier. The stored transaction information is processed to generate targeted marketing opportunities for presentation to the user associated with the secondary identifier.

In use, the apparatus and method may externally transfer data between a plurality of computers (e.g., between a computerized point-of-transaction unit and a transaction/marketing system). The point-of-transaction unit may extract, process, and transfer data pertaining to a user's transaction to at least one other computerized system (e.g., multiplatform marketing and research system) where the data may be analyzed to determine targeted marketing opportunities for transmission to a user or group of users, for example.

### BACKGROUND OF THE INVENTION

Credit and debit cards are widely used to conduct commerce across the globe. The current credit card system has been largely based on coding of single set of alphanumeric characters on the front of the card that make up the credit card account numbers, along with characters on the front and back of the cards or other security devices such as holographic stickers to provide secondary security and identification measures. A single magnetic stripe on the back of cards is also a common feature. The stripe is used to encode a secure, unique digital data sequence that is read by an electronic magnetic card reader stripe swiping system and used to validate the card at manned and automated retail checkout counters.

The current system for coding, verifying, and capturing credit card transaction information is well established. For transactions occurring over the phone, or for online transactions, credit card users manually provide their credit card account number, as well as, a security account number and an expiration date. Additionally, card account holders may be asked to input their address or a personal pin number. In some cases, they may be asked to answer a personal question stored by the card company, such as the name of their “favorite pet” or their “mother's maiden name.”

Conventional models address the need to create unique account numbers, and to provide other means to verify those account numbers and their corresponding users. These other means include the use of an expiration date or security code printed on the front and back of a card, or the use of a magnetic stripe holding programmed information. The magnetic stripe is an institutionalized technology in the credit and debit card industry. Today, most financial cards follow International Organization for Standardization (ISO) standards to ensure read reliability world wide, and along with transit cards constitute the largest users of magnetic stripe cards.

The magnetic stripe is written and read in much the same way that audio recording tape is written and read, except that the data are binary digits—1s and 0s—instead of sounds. The magnetic stripe is made of a material that can be magnetized. To write data onto the stripe, the card is dragged over a tiny electromagnet. Pulses of electrical current are forced through the electromagnet windings in one direction or the other, to magnetize tiny spots on the stripe material. Perhaps one direction of magnetization represents a “1”, while the opposite direction represents a “0”; but more likely a slightly more complicated system is used. Companies that deal with these cards have agreed among themselves how to use arrangements of 1s and 0s to represent the letters and numbers that they want to store on the stripe.

To read the data, the card is dragged over a tiny coil of wire. Movement of the magnetized spots past the coil causes small electrical voltages to appear in the coil, and from these voltages the stored 1s and 0s can be deduced. In practice, the coil used to read the stripe is very similar to the electromagnet used to write the stripe. These electromagnets are mounted in “write heads” and “read heads,” which typically hold not one but several electromagnets, side by side, so that several “tracks” of magnetized spots are written and read simultaneously.

A standard card employing a magnetic stripe may have any of three tracks, or a combination of these tracks. Track 1 was the first track standardized. This layout was developed by the International Air Transportation Association (IATA) and includes 210 bits per inch (“bpi”), meaning the number or 0s or 1s that one head can write on each inch of stripe, with room for 79 characters. It includes the primary account number (up to 18 digits) and the account holder's name (up to 26 alphanumeric characters).

Track 2 was developed by the American Bankers Association (ABA) for on-line financial transactions. This layout includes 75 bpi with room for 40 numeric characters. It includes the account number (typically 16 digits), expiration date, service code, pin verification data, and a discretionary data field.

Track 3 is also used for financial transactions. The difference is its read/write ability. The layout includes 210 bpi with room for 107 numeric digits. Track 3 may also include an enciphered Personal Identification Number (PIN), country code, currency units, amount authorized, subsidiary account information and other restrictions.

Instead of, or in addition to, simply using magnetic stripes that store data, cards may also contain microcontrollers that store data and run programs. These “smartcards” contain an internal microcontroller that runs a program as soon as it is inserted in a smartcard socket. The firmware running in the smartcard is an interpreter with a passive nature, which means that instead of initiating its own actions, it merely responds in a predetermined way to commands sent in from the outside world. Furthermore, like most modern microcontrollers, its program memory can be locked so that it can be neither examined nor modified by any external means. Smartcards generally contain encryption routines built in their firmware. The combination of the three aforementioned characteristics makes these devices particularly well suited for applications requiring high security.

Other methods of communicating user transaction or purchase information includes the use of optical memory cards. Optical memory cards use a technology similar to the one used with music CDs or CD ROMs. A panel of the “gold colored” laser sensitive material is laminated in the card and is used to store the information. The material is comprised of several layers that react when a laser light is directed at them. The laser burns a tiny hole (2.25 microns in diameter) in the material which can then be sensed by a low power laser during the read cycle. The presence or absence of the burn spot indicates a “one” or a “zero.” Because the material is actually burned during the write cycle, the media is a write once read many (WORM) media and the data is non volatile (not lost when power is removed).

Optical cards can currently store between 4 and 6.6 MB of data which gives the ability to store graphical images (e.g. photographs, logos, fingerprints, x-rays, etc.). The data is encoded in a linear x-y format. ISO/IEC 11693 and 11694 standards provide additional details regarding the encoding format. The primary users of optical technology today are: the medical and healthcare industry; prepaid debit cards; cargo manifests; admission pass season tickets; auto maintenance records; and retail purchase cards. Radio Frequency Identification (RFID) embedded chips may also be used to help ensure security, validity and proper use of the credit or debit cards.

In utilizing these basic systems, as well as other systems, the credit card business has enjoyed a business that has grown in size each year with hundreds of billions of dollars spent by consumers with credit and debit cards each year.

### SUMMARY OF THE INVENTION

Unfortunately, the existing conventional systems have certain limitations in use and deployment. To start with, an alphanumeric system has certain base limitations due to the number of total characters in use that make up the combination of numbers or letters in an account number. For instance, an alphanumeric character set that includes 36 total characters has exponentially fewer possible combinations than an identification set that includes millions of possible characters. Extending the number of characters available for account numbers and security codes may be one way to reduce fraud and piracy as well as providing a large pool of numbers available for new functions such as enhanced marketing tools.

The magnetic stripe and database elements in the credit card business used as the primary methods to corroborate automatic data collection and identification for credit and debit card users are also long established systems that create few barriers to imposters and limit the framework upon which new services, such as enhanced marketing tools may be built. Similarly, although the implementation of security and automatic data collection measures such as Radio Frequency Identification (RFID) and microprocessor implementation within cards certainly help the situation, these uses are only safeguards against specific types of uses, namely retail transactions, either manned or unmanned. Magnetic stripes, microprocessors and RFID chips installed within credit cards do nothing to stem the flow of online, mail/courier or phone transactions as the magnetic stripes, microprocessor or RFID chip need to be deployed locally to validate the card further.

The existing credit card system, including the basic transaction account number system, has been in place for decades. As a consistent and single platform for the credit and debit card industry, it has also been susceptible for fraudulent attack precisely because it provides an established target to focus upon to find solutions to hack the credit card systems in a variety of ways.

Current systems also lack the ability to easily track a user who opts into an advertising system, separate from the users other data associated with the cards primary numbering system (i.e., transaction account number). In part because user transaction and purchase information is maintained by the card issuer. However, users often carry a number of different transaction cards that may use for different purposes (e.g., personal or business). Further, a user may use different cards for different reasons (interest rates, reward points, retail establishment, etc.). Thus, the user's total purchasing activity may not be captured in a single database.

Accordingly, there is a need for a new, integrated system that provides an immediate method where a user who opts into an advertising system can easily be tracked, separate from the user's other data associated with the cards primary numbering system for security and privacy reasons, so that the user can be solicited by certain marketing and advertising companies who have availed themselves of the system. Such a system may provide only proscribed access based upon the system rules and the specific instructions from all participants and parties to the new coding system designed specifically for marketing, advertising, and research companies.

A method and corresponding apparatus for processing and transmitting demographic data based on secondary marketing identifier in a multi-computer environment in accordance with an embodiment of the present invention is provided. The example embodiment transmits targeted marketing opportunities to a user and includes providing a primary identifier associated with a transaction account, and a secondary identifier associated with a marketing account. Received transaction information related to the transaction account is associated with the secondary identifier and the information and results are stored therein. A user is associated with the secondary identifier. The stored transaction information is processed to generate targeted marketing opportunities for presentation to the user.

The primary identifier and secondary identifier may be stored on the same or separate magnetic strips located on the transaction card. In addition, the primary identifier may be represented by a first set of characters located on a transaction card, and the secondary identifier may be represented by a second set of characters located on the transaction card. The characters may be alphanumeric characters or may correspond to a plurality of symbols, directional symbols, colors, or audio data.

The transaction account may be a credit card account, debit card account, banking account, or similar financial card. The marketing account may be related to a marketer, advertiser, or merchandiser. The system may also include authenticating a sender of the transaction information, or encrypting and decrypting the transaction information. The transaction information may be stored in a relational database. Transaction information may be linked to the secondary identifier such that the user's identity remains anonymous.

Marketing opportunities may be transmitted by at least one computer (e.g., transaction or marketing unit) to the user(s) via e-mail, telephone, instant message, or postal mail. A group of users may be identified based on geographical information and marketing opportunities may be presented to the group via print advertisements in a local or national publication, television advertisements, radio advertisements, online advertisements, or bulk mailers. Processing the marketing opportunities may include refining the marketing opportunities based on gathered purchasing data, demographic data, geographic data, system logic, or a marketing partner's target parameters.

Revenue may be generated based on, for example, revenue share or direct fees. Inducements such as points, discount fees, lottery style rewards, frequency of use rewards, monetary compensation, gift cards, or coupons may be provided to participating users. The centralized nature of the system may also facilitate advertiser communications, and manage responses between advertisers and marketing partners or users via the system.

In use the apparatus and method may externally transfer data between a plurality of computers (e.g., between a computerized point-of-transaction unit and a transaction/marketing system). The point-of-transaction unit may extract, process, and transfer data pertaining to a user's transaction to at least one other computerized system (e.g., multiplatform marketing and research system) where the data may be analyzed to determine targeted marketing opportunities for transmission to a user or group of users, for example.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a schematic view of the front of a card that may be used in systems according to principles of the present invention;

FIG. 2 is a schematic view of the back of another card that may be used in systems according to principles of the present invention;

FIG. 3 is a block diagram of a system according to embodiments of the present invention;

FIG. 4 is a block diagram of a system according to embodiments of the present invention;

FIG. 5 is a more detailed block diagram of the system depicted in FIG. 4 according to embodiments of the present invention;

FIG. 6 is a flowchart illustrating an embodiment of the present invention;

FIG. 7 is a schematic view of a computer network environment in which the principles of the invention may be implemented.

FIG. 8 is a block diagram of the internal structure of a computer from the FIG. 7 computer network environment.

### DETAILED DESCRIPTION OF THE INVENTION

A description of example embodiments of the invention follows.

The present invention, in accordance with an example embodiment, relates to the creation of a credit card system that utilizes a second set of characters (i.e. secondary identifier) to connect a credit card or debit card user to a multiplatform marketing and research network. The information acquired by the system allows the system to present the card user with marketing opportunities and has the ability to refine the marketing opportunities based upon information gathered by the system. “Secondary identifier” and “marketing account number” may be used interchangeably herein.

The use of the second set of characters works identically to the first set of characters (i.e., the traditional account number of the front of the card) except that the coding logic for the second set of characters is different from the first set of characters. The second set of numbers, in addition to being printed on the front of the card may also be stored on the magnetic strip on the back of the card.

The result is that the second number strip, also known as the Marketing Account Magnetic Strip (MAMS) is read by magnetic card readers the same way a traditional credit card number is read. The difference is that the MAMS alphanumeric code read by the magnetic card reader may be sent to a separate secure server system using modern authentication and encryption methods. Transaction information generated by the card user is stored in a database wherein the system may synthesize and process the information for marketing, advertising, or market research purposes. The users pure entry into the system, the users specific demographic data obtained at the time of user registration to the system, and the users specific purchasing habits may all be used by the system to generate appropriate marketing matches based upon system logic and based upon marketing partners desires to reach all or certain parts of the system's member audience.

Members may be contacted individually by the system marketing partners via email, phone, instant message or mail. Group demographic data may be used to geographically locate a broader advertising member audience for use with advertising campaigns such as print ads in local or national publications, television or radio ads, online ads or bulk mailers.

Advertisers may have all of their communications facilitated by the system which will also manage the responses and reporting to the MAMS marketing partners and, in certain instances, the MAMS card users. The timing of marketing opportunities could be immediate utilizing technology such as that disclosed in co-pending U.S. Patent Application Ser. No. 60/756,082 filed Jan. 4, 2006, entitled “Transmission of Data for Marketing Purposes”, which is hereby incorporated by reference in its entirety.

The MAMS network may generate income by requiring payment from marketing partners via a revenue sharing model, direct fees, or similar fee structure, The MAMS card members could be induced to use the system via lower interest rates, incentives via affinity program point inducements or discounted fees, bonus payments, lottery style inducements, frequency of use inducements, or coupon inducements. Targeted inducements may be based on implicit or explicit system synthesized user data.

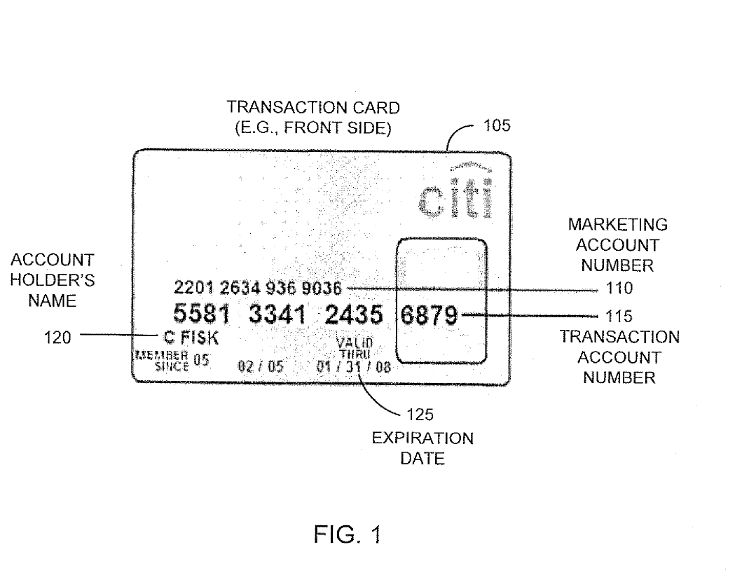

FIG. 1 illustrates the front of a card 105 that may be used in a system according to principles of the present invention. The front of the card 105 may appear similar to that of conventional transaction cards (e.g., credit or debit cards) and include an account holder's name 120, and an expiration date 125. A string or series of numerals (written digits) represents the credit or debit card transaction account number 115. For example, a transaction account number 115 may comprise four groups of 4 numerals, for a total of 16 digits, much like existing credit or debit card transaction account numbers.

A secondary identifier, such as a marketing account number 110, may also appear as a string or series of numerals on the front of the transaction card 105. The marketing account number 110 may be any combination of numerals and may further be grouped in a manner similar to that of the transaction account number 115, for example, three groups of four numerals and one group of three numerals. However, transaction and marketing account numbers 110, 115 used with the present invention are not limited to any particular quantity or combination of numbers or characters.

In an alternative example embodiment, the transaction account number 115 and/or marketing account number 110 may be replaced by a grouping of colors (not shown). The individual colors used in this embodiment, perhaps over 10,000,000 individual colors, may be stored in a database correlating to an individual name, such as “aqua” or “periwinkle” and used in the embodiment as a combination on the credit and debit cards to create an individual cardholder transaction account number 115 and marketing account numbers 110. For more details regarding the substitution of colors for numerals, reference can be made to co-pending U.S. patent application Ser. No. 11/695,984 filed Apr. 3, 2007, entitled “System and Method for Controlling Secured Transaction Using Color Coded Account Identifiers,” which is hereby incorporated by reference in its entirety.

In another alternative example embodiment, the transaction account number 115 and/or marketing account number 110 may be replaced by a grouping of directional symbols (not shown). The individual symbols used in this embodiment may be stored in a database correlating to respective names, such as “shamrock” or “up arrow” and used in this embodiment as a combination on the credit and debit cards to create an individual transaction account number 115 and/or marketing account number 110. For more details regarding the substitution of directional symbols for numerals, reference can be made to a co-pending U.S. patent application Ser. No. 11/695,980 filed Apr. 3, 2007, entitled “System and Method for Controlling Secured Transaction Using Directionally Coded Account Identifiers,” which is hereby incorporated by reference in its entirety.

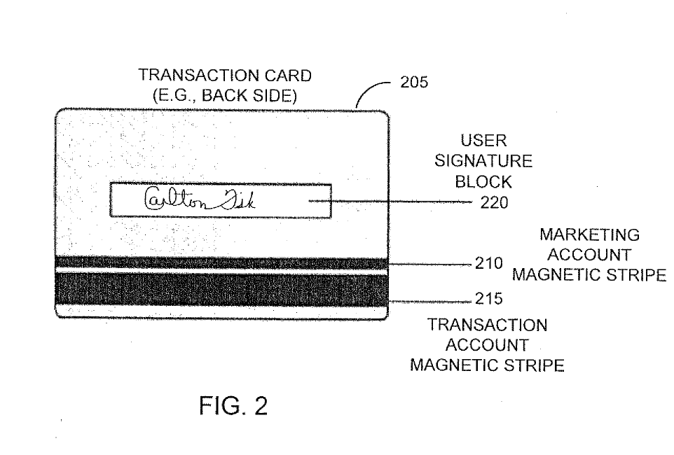

FIG. 2 illustrates the back of a transaction card 205 according to principles of the present invention. In FIG. 2, the back of the transaction card 205 has a standard user signature block 220 that provides a section for the account holder to furnish an authorized signature. The transaction card 205 also includes a familiar looking transaction account magnetic stripe 215 in its customary position on the back of the transaction card 205. In addition to conventional magnetic stripe information, such as user name, account number, Personal Identification Number (PIN), and financial institution, the transaction account magnetic stripe 215 may also include a secondary identifier associated with a user's marketing account.

The magnetic stripe(s) (e.g., 215) may be encoded to store various data fields related to user account information according to various standards known in the art. These standards specify the physical characteristics of the card 105, magnetic stripe media characteristics, location of data tracks, and financial transaction information. For example, the transaction account magnetic stripe 215 may contain multiple tracks where, for example, track 1 conforms with the International Air Transportation Association standard and tracks 2 and 3 conform with the American Bankers Association standard for financial transactions.

In an example embodiment track 3 may include a secondary identifier such as a marketing account number associated with a user's marketing account information. The secondary identifier may be stored in an account number field, a discretionary field, or other similar field located within track 3. Alternatively, the secondary identifier may be stored in a field or fields located within tracks 1 or 2 along with other transaction account information (e.g. credit card account information).

In an alternative example embodiment, the transaction card 205 may include two magnetic stripes. The first, a transaction account magnetic stripe 215, may be associated with the user's conventional transaction account information. The second, a marketing magnetic stripe 210, may be used to store the secondary identifier associated with the user's marketing account information.

It should be apparent to one skilled in the art that the example embodiments presented herein are presented merely for illustrative purposes and in no way limit the concept of a secondary identifier associated with a marketing account to a particular location on the magnetic stripe(s). The example embodiments of the invention are equally applicable to one or more magnetic stripes having 1, 2, or 3 tracks. Nor is the present invention limited to the data fields described above. For instance, the ordering of the fields in a respective track may vary, and the size or location of the data fields may vary as well.

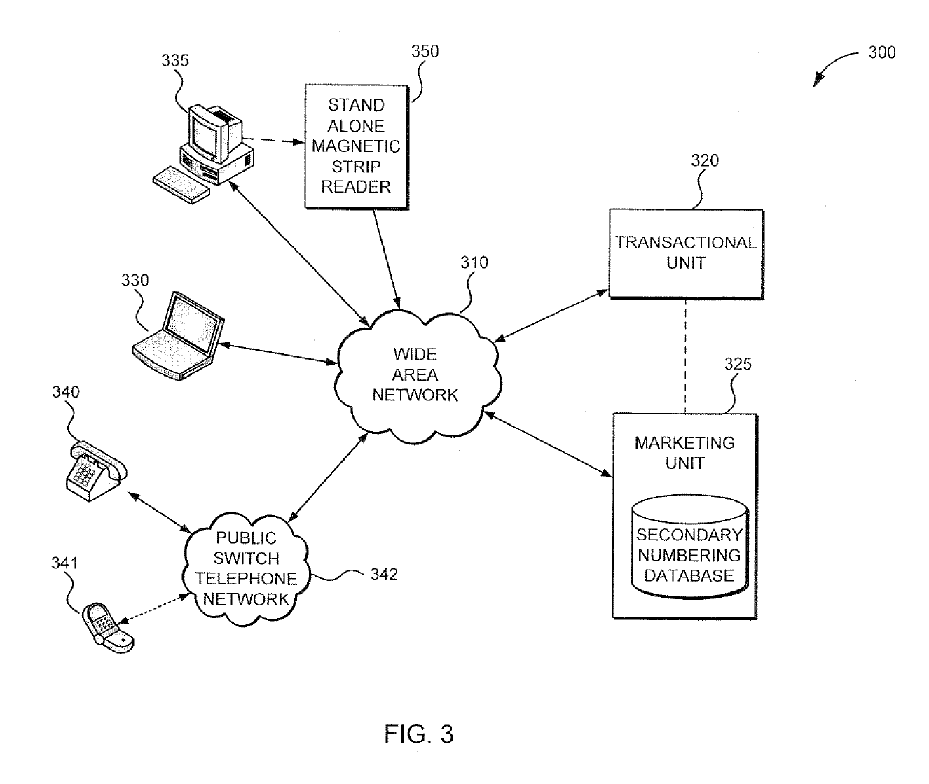

FIG. 3 illustrates a system 300 according to principles of the present invention. The invention method and apparatus presents targeted marketing opportunities to a user. The system may include an acquisition unit such as a personal computer 330, telephone 340, mobile telephone, Personal Digital Assistant (PDA), or similar mobile communication device 341, point-of-transaction unit 335 (e.g., an electronic cash register), and magnetic strip reader 350 (a stand-alone unit 350 or integrated into the point-of-transaction unit 335). The acquisition unit provides a user access point to a network 310 for transmitting a transaction request to a transaction unit 320.

The transaction unit 320 may receive a request for access to a transaction system from an acquisition unit, where the request may include transaction information regarding, for example, a user's purchase. The request may occur through any number of account acquisition units at a point-of-transaction. For example, a telephone 340 or mobile phone 341 may acquire the account identification data from a user and transmit the transaction request through a public switched telephone network 342 to the network 310. In terms of online, phone or mail transactions, the user simply fills in the transaction and marketing account numbers 110, 115 by entering both numbers where appropriate.

The marketing unit 325 may also receive transaction information and a secondary identifier where the secondary identifier may be used to associate the transaction information with a user's marketing account. The transaction unit 320 may also be in communication with the marketing unit 325, either local or remote, distributed or central, or other configuration. The marketing unit 325 may store user marketing account information, such user identification information, previous purchase information, demographic data, etc.

In use, a user's transaction information (e.g., a retail purchase) may be acquired and communicated to the transaction unit 320 in a manner similar to existing transaction systems, such as credit card or debit card systems. For example, a user may execute a purchase at a retail establishment where the user's transaction account number 115 and secondary marketing number 110 are acquired when the user's credit card 105 is “swiped” using a magnetic strip reader attached to or associated with a point-of-transaction unit 335. The user's transaction account number 115 and secondary identifier may be entered manually by a sales person at the point-of-transaction unit 335 as may be the case when the magnetic strip reader 350 is faulty or nonexistent. Alternatively, a user may manually provide the transaction account number 115 and secondary identifier, such as when an on-line or telephone purchase is executed.

One skilled in the art will recognize that the account information including a secondary identifier may be stored on a smart card processor, which can hold this data along with other important data. A scanner may then utilize the reader's network connection to communicate this information to the transaction unit 320 and marketing unit 325 as described above. Further, transaction information together with the secondary identifier may be stored locally on the smart card when, for example, a network connection is down or nonexistent. The transaction information associated with the secondary identifier may be tallied and later communicated to the marketing unit 325 when, for example, a network connection is available.

The marketing unit 325 may then process and analyze information stored in the secondary numbering database in order to target specific users based on system logic and a marketing partner's or advertiser's target criteria. Once a desired user is identified, targeted promotions may be communicated to the user is a substantially real-time manner via the point-of-transaction unit 335, telephone 340, 341, or computer 330, or at a later point in time via email, post mail, telephone solicitation, etc. Alternatively, the marketing unit 325 may communicate promotional opportunities to a targeted group via, for example, print advertisements, bulk mailers, television or radio advertisements, etc.

One skilled in the art will recognize that the system shown in FIG. 3 illustrates a high level network, and that consistent with principles of the present invention, data transmissions for secure account verifications may be made in other network configurations at central and sub-central data and data verification points using a variety of acquisition units.

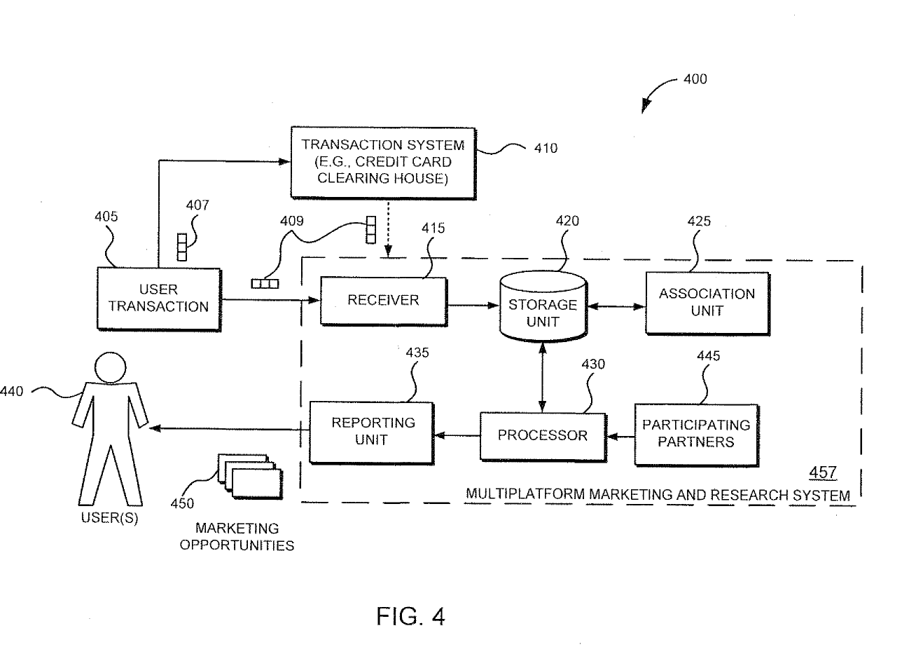

FIG. 4 is a block diagram illustrating a system according to principles of the present invention. A multiplatform marketing and research system 457 may include a receiver 415, a storage unit 420, an association unit 425, a processor 430, and a reporting unit 435.

A user 440 may initiate, for example, a retail purchase using a transaction card 105, 205 as described above in reference to FIGS. 1-3. Purchase information is communicated to a transaction system 410 (e.g., credit card clearinghouse or financial institution) including conventional transaction information 407 such as a user name, account number, expiration date, purchase amount, items purchased, retail establishment, etc. In addition, marketing information 409 may also be communicated to the multiplatform marketing and research system 457. This information may include transaction information 407 similar to that communicated to the conventional transaction system 410 together with a secondary identifier associated with the user's marketing account. Alternatively, marketing information 409 may be forwarded from the transaction system 410 to the multiplatform marketing and research system 457.

The receiver 415 receives the marketing information 409, and may optionally format the data where the data is then forwarded to a data storage unit 420 for use with, for example, a relational database (not shown). The association unit 425 may be used to associate the secondary identifier with user information stored in a secondary numbering database that may be located in, for example, the storage unit 420.

Clients or subscribers of the invention system and method may include participating partners 445 such as advertisers or marketers. The participating partners 445 may use system logic or provide target criteria in order to identify a desired consumer or group of consumers. The processor 430 may use the search criteria or system logic to synthesize and process appropriate marketing opportunities 450 based on the target criteria. The reporting unit 435 may communicate at least one marketing opportunity 450, such as a coupon, instant discounts, etc., to selected user(s) 440 via a variety of different delivery mechanisms.

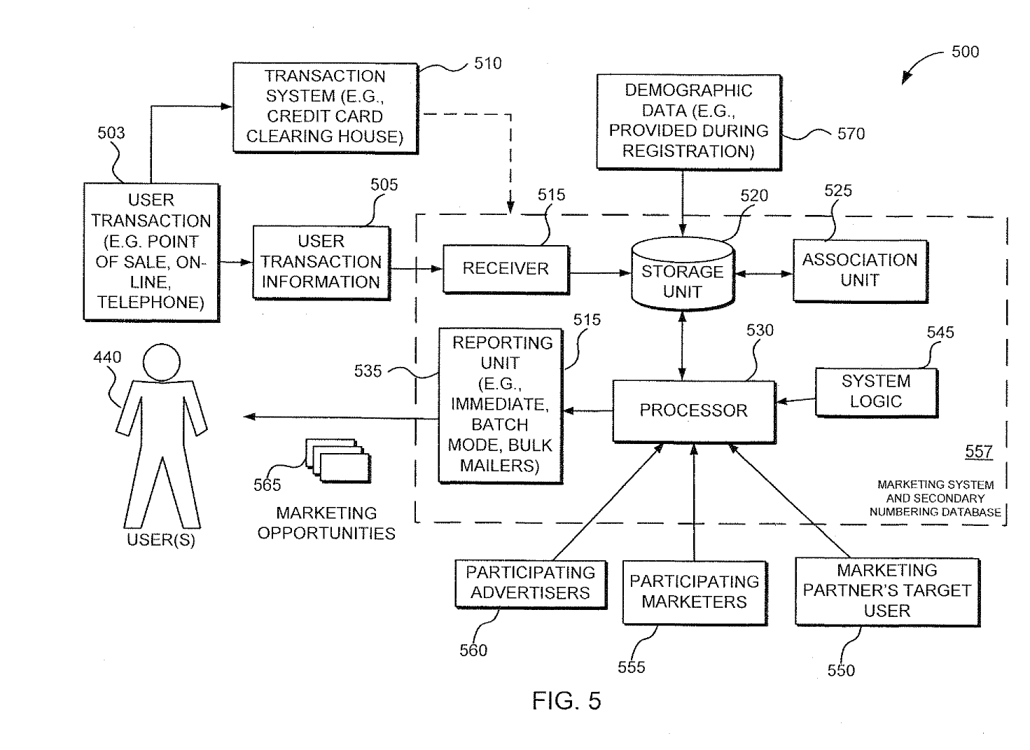

FIG. 5 is a block diagram illustrating in further detail a system 500 according to principles of the present invention. A discussion of an example embodiment of the system in use may help further clarify operation of the system and method. A card user 440 may execute a purchase at a retail establishment wherein the user's credit card 105, 205 is “swiped” through a magnetic card reader where both the transaction account number 115 and marketing account number 110 are determined, Alternatively, a user 440 may execute a purchase over a telephone or online and manually provide the transaction account number 115 and marketing account number 110 displayed on the front of the user's credit card 105. Purchase transaction information may be communicated to a transaction system 510, such as a credit card clearinghouse, financial institution, or captive transaction system. In addition, similar transaction information and a secondary identifier (i.e., marketing account number) may also be communicated to a marketing system and secondary numbering database 557. The transaction information is received by a receiver 515, optionally formatted, and further communicated to a storage unit 520. As was described above in reference to FIG. 4, an association unit 525 may be used to associate the secondary identifier with the card user 440 via a database query, lookup table, or other matching technique known in the art.

The marketing system 557 may contain demographic data about a user obtained during a user's initial registration, for example, name, address, income, occupation, hobbies, etc. Alternatively, a user may opt-in during a particular purchase or at a later time or event. Additional user information may also be derived from other sources (not shown), such as credit reporting databases, census information, driving records, insurance databases, and other such sources in order to more accurately target particular consumers for specific marketing opportunities 565.

System logic 545 may also be used to more accurately tailor marketing opportunities 565 to the user(s) 440. System logic 545 may entail executing a simple database query where a participating advertiser 560 or participating marketer 555 is interested in targeting users that, for example, purchase paper towels once a week in order to provide a coupon for a competing product.

However, the invention may be used to generate more elaborate multiplatform analysis and user identification. Multiplatform analysis allows a marketer or advertiser to analyze multiple sources of information, such as purchasing history across different retail and service providers (e.g., food, books, travel, club membership dues, etc.) providing a horizontal and vertical view of a user's purchasing habits. This type of analysis allows the invention to more effectively identify consumers that may be more interested in complementary marketing opportunities.

For example, the invention may be used to target a consumer that regularly eats at Italian restaurants and has recently purchased the book “Under the Tuscan Sun” in order to present travel related marketing opportunities 565. Similarly, a user may purchase clothing in a department store located within a shopping mall. The processor 530 may be used to analyze the user's purchasing habits to determine that the user has a history of frequenting Mrs, Fields® cookie stores and that there is a Mrs. Fields® cookie store in the same mall. The invention may then be used to generate a Mrs, Fields® cookie coupon for delivery to the user. The system 400, 500 may be used to present a coupon to the user at the point of sale (i.e., the cash register where the clothing purchase was executed). Alternatively, a text message could be sent to the user's mobile phone 341 that could be redeemable for a discount or in the form of a barcode that could be displayed on a user's mobile phone 341 and scanned by the retailer or a discount code for manual entry by the sales person.

The marketing opportunities 565 may be presented to the user(s) 440 in a substantially real-time manner (e.g., immediately printing out a coupon at a cash register or communicating the opportunity other redeemable media) or delivered to the individual user at a later time (e.g., post mail or email). Alternatively, using the appropriate system logic and marketing/advertising participator's 440 search criteria, a target group of users (e.g., 440) may be identified where marketing opportunities 565 may be communicated to the group using bulk mailers, print advertisements (e.g., newspaper ads), billboard advertisements, television advertisements, and the like.

The block diagrams of FIGS. 4 and 5 are merely representative and that more or fewer units may be used, and operations may not necessary be divided up as described herein. Also, a processor executing software may operate to execute operations performed by the units, where various units, separately or in combination may represent a processor, field programmable gate array (FPGA), application specific integrated circuit (ASIC), or the like. It should be understood that the block diagrams may, in practice, be implemented in hardware, firmware, or software. If implemented in software, the software may be any form capable of performing operations described herein, stored on any form of computer readable-medium, such as RAM, ROM, CD-ROM, and loaded and executed by a general purpose or application specific processor capable of performing operations described herein.

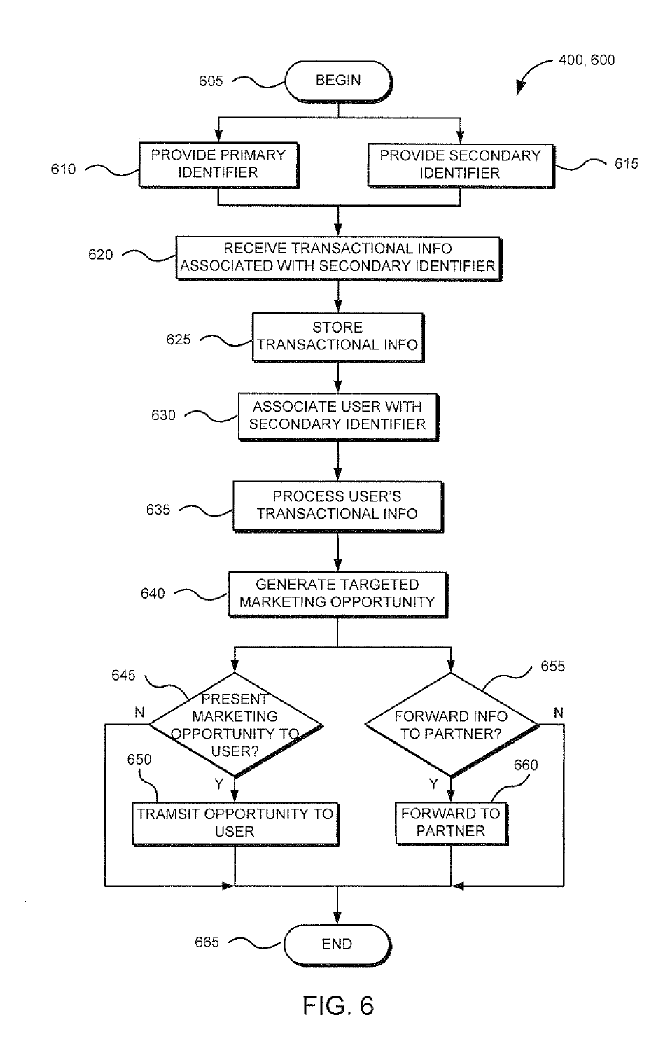

FIG. 6 illustrates an exemplary transaction flow diagram 600 of a system 400 according to principles of the present invention. The flow diagram 600 of system 400 begins (605) when a user 440 attempts to initiate a transaction 405 by providing a vendor with a transaction card 105 that contains a primary identify (e.g., transaction account number 115) (610) and a secondary identifier (e.g., marketing account number 110) (615). After the transaction card 105 is swiped though a magnetic card reader (or transaction and marketing account numbers are manually entered), the system 400 then transmits the transaction information 409 and the secondary identifier 110 to a receiver (620) where it may be stored (625). The system 400 then associates a user 440 with the secondary identifier (630). At step 635, the system 400 processes the user's transaction information.

At step 640, the system 400 generates targeted marketing opportunities 450 based upon target user criteria. If marketing opportunities 450 are to be presented to the user (645), they may be transmitted (650) in a manner appropriate with regard to delivery medium (e.g., instant message, mail, print advertisement) and the flow diagram 600 ends (665). Returning to step 640, the system 400 also determines if the transaction information 409 and/or marketing opportunity 450 is to be forwarded to a participating partner(s) 445, and if so, the system 400 transmits the information to the appropriate partner(s) 445 at step 660 and the flow diagram 600 ends (665). If not, the flow diagram 600 ends (665).

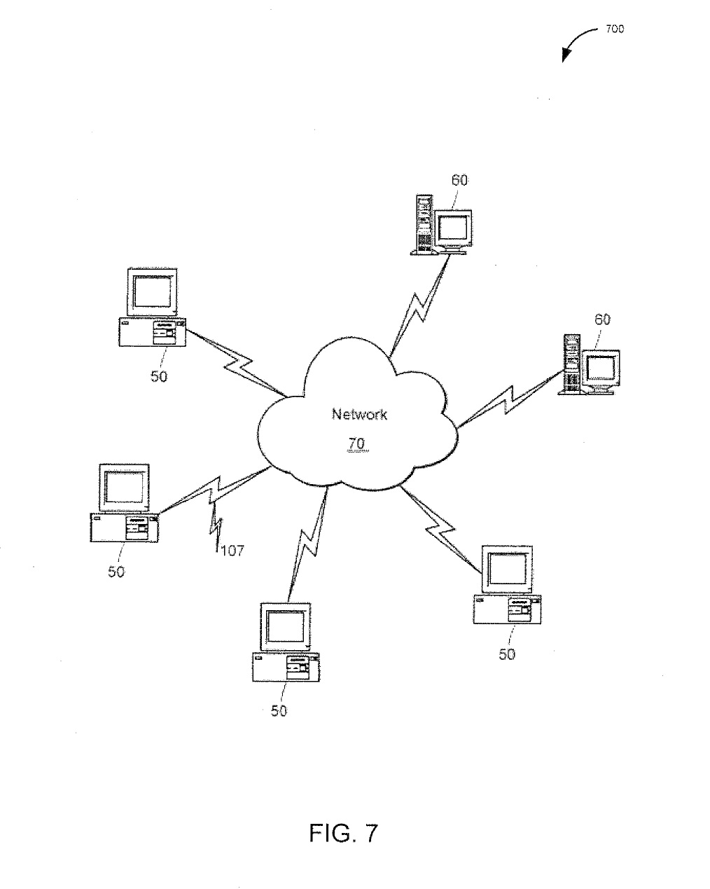

FIG. 7 illustrates a generalized computer network 700 or similar digital processing environment in which the invention may be implemented.

Client computer(s)/devices 50 (e.g., point-of-transaction unit 335 or a consumer's home computer 330) and server computer(s) 60 (e.g., transactional unit 320 or marketing unit 325) provide processing, storage, and input/output devices executing application programs and the like. Client computer(s)/devices 50 can also be linked through a communications network 70 to other computing devices, including other client devices/processes 50 and server computer(s) 60. Communications network 70 can be part of a remote access network, a global network (e.g., the Internet), a worldwide collection of computers, Local area or Wide area networks (e.g., 310), and gateways that currently use respective protocols (TCP/IP, Bluetooth, etc.) to communicate with one another. Other electronic device/computer network architectures are suitable.

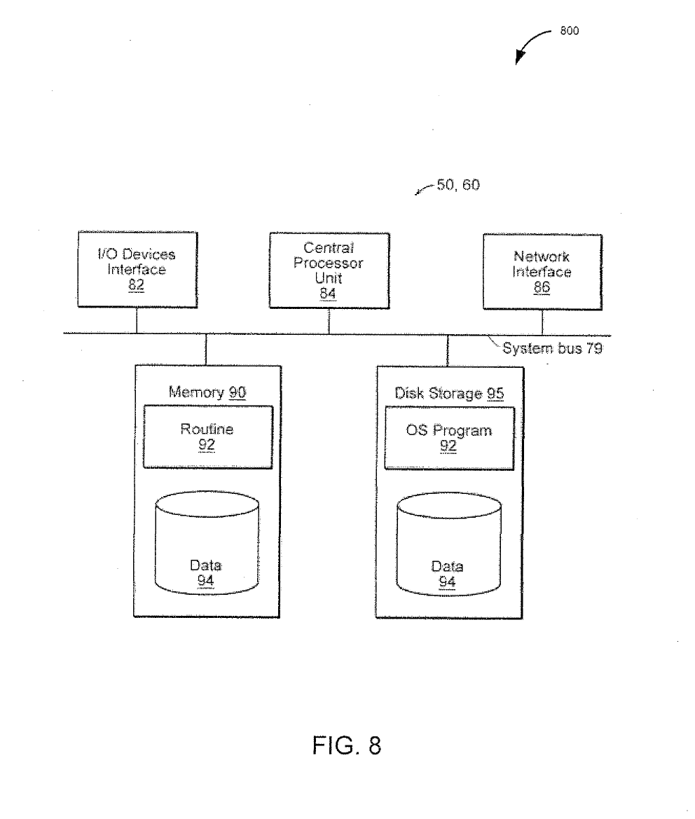

FIG. 8 is a diagram of the internal structure of a computer 50, 60 (e.g., client processor/device 50 or server computers 60) in the computer system of FIG. 7. Each computer 50, 60 contains system bus 79, where a bus is a set of hardware lines used for data transfer among the components of a computer or processing system. Bus 79 is essentially a shared conduit that connects different elements of a computer system (e.g., processor, disk storage, memory, input output ports, network ports, etc.) that enables the transfer of information between the elements. Attached to system bus 79 is I/O device interface 82 for connecting various input and output devices (e.g., keyboard, mouse, displays, printers, speakers, etc.) to the computer 50, 60. Network interface 86 allows the computer to connect to various other devices attached to a network (e.g., network 70 of FIG. 7). Memory 90 provides volatile storage for computer software instructions 92 and data 94 used to implement an embodiment of the present invention (e.g., remote monitoring, processing, storing and reporting code 63 detailed above). Disk storage 95 provides non-volatile storage for computer software instructions 92 and data 94 used to implement an embodiment of the present invention. Central processor unit 84 is also attached to system bus 79 and provides for the execution of computer instructions.

In one embodiment, the processor routines 92 and data 94 are a computer program product (generally referenced 92), including a computer readable medium (e.g., a removable storage medium such as one or more DVD-ROM's, CD-ROM's, diskettes, tapes, etc.) that provides at least a portion of the software instructions for the invention system. Computer program product 92 can be installed by any suitable software installation procedure, as is well known in the art. In another embodiment, at least a portion of the software instructions may also be downloaded over a cable, communication and/or wireless connection. In other embodiments, the invention programs are a computer program propagated signal product 107 embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present invention routines/program 92.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 50 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium and the like.

In some embodiments computer system 40 employs a Windows™ (Microsoft) operating system, in other embodiments a Linux operating system, and in other embodiments a UNTX™ operating system. Other operating systems and system configurations are suitable. Applicant claims trademark rights to the terms “Seethroo”, “Seethroo Observer”, and “Observer URL.”

Those of ordinary skill in the art should recognize that techniques involved in a system and method for providing standardized coded demographic data based on secondary marketing account number may be embodied in a computer program product that includes a computer usable medium. For example, such a computer usable medium can include a readable memory device, such as a solid state memory device, a hard drive device, a CD-ROM, a DVD-ROM, or a computer diskette, having stored computer-readable program code segments. The computer useable/readable medium can also include a communications or transmission medium, such as electromagnetic signals propagating on a computer network, a bus or a communications link, either optical, wired, or wireless, carrying program code segments as digital or analog data signals. The program code enables and supports computer implementation of the operations described in FIG. 5 or other embodiments.

While this invention has been particularly shown and described with references to example embodiments thereof, it will be understood by those skilled in the art that various changes in form and details may be made therein without departing from the scope of the invention encompassed by the appended claims.

What is claimed is:

1. A method of transmitting targeted marketing opportunities to a user comprising:
providing (i) a primary identifier associated with a transaction account and (ii) a secondary identifier associated with a marketing account;
receiving transaction information related to the transaction account and associating the received transaction information with the secondary identifier;
storing the received transaction information;
associating a user with the secondary identifier;
processing the stored transaction information to generate targeted marketing opportunities for the user associated with the secondary identifier; and
transmitting the marketing opportunities to the user.

2. The method as claimed in claim 1 wherein the primary identifier is associated with account information stored on a transaction magnetic stripe located on a transaction card, and the secondary identifier is associated with account information stored on a separate marketing account number magnetic stripe located on the transaction card.

3. The method as claimed in claim 1 wherein the primary identifier is represented by a first set of characters, symbols, directional symbols, or colors located on a transaction card, and the secondary identifier is represented by a second set of characters, symbols, directional symbols, or colors located on the transaction card.

4. The method as claimed in claim 1 wherein the transaction account is a credit card account, a debit card account, or a banking account.

5. The method as claimed in claim 1 wherein the method further includes any of the following: authenticating a sender of the transaction information, authenticating a sender of the marketing opportunities, or encrypting or decrypting the transaction information.

6. The method as claimed in claim 1 wherein the user's identity remains anonymous.

7. The method as claimed in claim 1 wherein transmitting the marketing opportunities includes transmitting the marketing opportunities by contacting the user via e-mail, telephone, instant message, or postal mail.

8. The method as claimed in claim 1 further including identifying a group of at least two users and transmitting the marketing opportunities via print advertisements in a local or national publication, television advertisements, radio advertisements, online advertisements, or bulk mailers.

9. The method as claimed in claim 1 wherein processing the marketing opportunities includes refining the marketing opportunities based on at least one of the following: gathered purchasing data, demographic data, geographic data, system logic, or a marketing partner's target parameters.

10. The method as claimed in claim 1 further including providing targeted inducements to at least one user based on system synthesized user data, the inducements including any of the following: points, discount fees, lottery style rewards, frequency of use rewards, monetary compensation, gift cards, or coupons.

11. The method as claimed in claim 1 wherein the method is centralized and further includes:
facilitating advertiser communications;
managing responses between advertisers and marketing partners or users; and
reporting to marketing partners or users via the centralized marketing system.

12. The method as claimed in claim 1 wherein the marketing account is related to a marketer, advertiser, merchandiser, or participating partner.

13. An apparatus for transmitting targeted marketing opportunities to a user comprising:
a primary identifier associated with a transaction account, and a secondary identifier associated with a marketing account;
a receiver configured to receive transaction information related to the transaction account and associating the received transaction information with the secondary identifier;
a storage unit configured to store the received transaction information;
an association unit configured associate the secondary identifier with a user;
a processor configured to generate targeted marketing opportunities based on the stored transaction information; and
a reporting unit configured to present the marketing opportunities to the user.

14. The apparatus as claimed in claim 13 wherein information stored on a transaction magnetic stripe located on a transaction card represents the primary identifier, and information stored on a separate marketing account number magnetic stripe located on the transaction card represents the secondary identifier.

15. The apparatus as claimed in claim 13 wherein a first set of characters, symbols, directional symbols, or colors located on a transaction card represents the primary identifier, and a second set of characters, symbols, directional symbols, or colors located on the transaction card represents the secondary identifier.

16. The apparatus as claimed in claim 13 wherein the transaction account is a credit card account, a debit card account, or a banking account.

17. The apparatus as claimed in claim 13 wherein the receiver is configured to perform any of the following: authenticate a sender of the transaction data, authenticate a sender of the marketing opportunities, encrypt or decrypt the transaction information, or encrypt or decrypt the marketing opportunities.

18. The apparatus as claimed in claim 13 wherein the user's identity remains anonymous.

19. The apparatus as claimed in claim 13 wherein the reporting unit is configured to contact the user to present the marketing opportunities via e-mail, telephone, instant message, or postal mail.

20. The apparatus as claimed in claim 13 wherein the processor is configured to identify a group of at least two users, and the reporting unit is configured to present the marketing opportunities via print advertisements in a local or national publication, television advertisements, radio advertisements, online advertisements, or bulk mailers.

21. The apparatus as claimed in claim 13 wherein the processor is configured to refine marketing opportunities based on at least one of the following: gathered purchasing data, demographic data, geographic data, system logic, or a marketing partner's target parameters.

22. The apparatus as claimed in claim 13 wherein the apparatus is configured to provide inducements to participating users that include at least one of the following: points, discount fees, lottery style rewards, frequency of use rewards, monetary compensation, gift cards, or coupons.

23. The apparatus as claimed in claim 13 wherein the marketing system is centralized and further includes:
facilitating advertiser communications;
managing responses between advertisers and marketing partners or users; and
reporting to marketing partners or users via the centralized marketing system.

24. An system for generating targeted marketing opportunities for a user comprising:
means for providing a primary identifier associated with a transaction account and a secondary identifier associated with a marketing account;
means for receiving transaction information associated with the secondary identifier;
means for storing the transaction information;
means for associating a user with the secondary identifier; and
means for processing the user's transaction information to generate targeted marketing opportunities.

25. A computer program product for generating targeted marketing opportunities for a user, the computer program product comprising a computer readable medium having computer readable instructions stored thereon, which, when loaded and executed by a processor, causes the processor to:
provide a primary identifier associated with a transaction account and a secondary identifier associated with a marketing account;
receive transaction information associated with the secondary identifier;
store the transaction information;
associate a user with the secondary identifier;
process the user's transaction information to generate targeted marketing opportunities; and
present the marketing opportunities to the user.
